(19) United States
(12) Patent Application Publication
(10) Pub. No.: US 2026/0177399 A1
(43) Pub. Date: Jun. 25, 2026

(54) METHOD AND DEVICE FOR THE PARTIALLY AUTOMATED CREATION OF CONTENTS FOR A DIGITAL MAP

(71) Applicant: Robert Bosch GmbH, Stuttgart (DE)

(72) Inventor: Jan Rohde, Dettingen Unter Teck (DE)

(21) Appl. No.: 19/406,235

(22) Filed: Dec. 2, 2025

(30) Foreign Application Priority Data
Dec. 23, 2024 (DE) 10 2024 139 600.8

(51) Int. Cl. G01C 21/00

(52) U.S. Cl. CPC G01C 21/3833; G01C 21/387

(57) ABSTRACT

A method and a device for the partially automated creation of contents for a digital map. The method includes: reading in the digital map; receiving data values of the surroundings which represent the surroundings of at least one vehicle; automatically generating first map contents from the received data values of the surroundings; checking the first map contents; confirming or adjusting the first map contents; automatically calculating second, secured map contents with the aid of the checked and confirmed or adjusted first map contents using secured algorithms; inserting the second, secured map contents into the digital map; and providing the digital map.

### CROSS REFERENCE

The present application claims the benefit under 35 U.S.C. § 119 of Germany Patent Application No. DE 10 2024 139 600.0 filed on December 23, 2024, which is expressly incorporated herein by reference in its entirety.

### FIELD

The present invention relates to a method for the partially automated creation of contents for a digital map and to a device for executing the method.

### BACKGROUND INFORMATION

A system is described in Germany Patent Application No. DE 10 2019 214 603 A1 that divides map data into different data sets and calculates them separately to form localization maps.

### SUMMARY

The detection of the vehicle's surroundings using sensors such as radar and video is a fundamental component of modern driver assistance systems and automated vehicle systems. The generated models of surroundings are often supplemented by additional contents from navigation, localization or planning maps such as routes outside the sensor detection range. The utilized maps are provided to the vehicle system via a map service.

Sensor systems (e.g. radar, video, LiDAR, ultrasound, …) of many modern vehicles meet functional safety requirements which are classified, for example, using the ASIL level according to ISO 26262. In this way, with special mapping vehicles, map contents can be created that are already designated as secured and may be used to provide safety-relevant driving functions. Alternatively, unsecured map contents can be manually checked to ensure security. Both approaches are costly, do not scale for lower road classes and are therefore difficult to use, in particular in urban environments.

According to an example embodiment of the present invention, a method for the partially automated creation of contents of a digital map comprises a step of reading in the digital map, a step of receiving data values of the surroundings which represent the surroundings of at least one vehicle, a step of automatically generating first map contents from the received data values of the surroundings, a step of checking the first map contents, a step of confirming or adjusting the first map contents, a step of automatically calculating second, secured map contents with the aid of the checked and confirmed or adjusted first map contents using secured algorithms, a step of inserting the second, secured map contents into the digital map, and a step of providing the digital map.

A digital map is understood to mean a map that can be used, for example, to locate and/or navigate a partially, highly or fully automated vehicle. An automated vehicle is understood to mean a vehicle that is designed according to one of the SAE levels 1 to 5 (see the standard SAE J3016).

The digital map can consist of different sub-maps that fulfill different functions. For example, the digital map includes sub-maps for the localization, navigation, or behavior planning of an automated vehicle.

The contents of the digital map are understood to mean elements of one or more sub-maps of the digital map. Such elements represent tangible or intangible objects and information that are used in particular for controlling and/or planning the behavior of an automated vehicle, such as roads, lanes, traffic signs, intersections, buildings or weather conditions.

Data values of the surroundings are understood to mean, for example, data values that are recorded by at least one environmental sensor system of at least one vehicle. An environmental sensor system is understood to mean at least one video sensor and/or at least one radar sensor and/or at least one lidar sensor and/or at least one further sensor that is designed to record the surroundings of a vehicle in the form of data values of the surroundings. In one possible embodiment of the present invention, the environmental sensor system comprises, for example, a computing unit (processor, working memory, hard drive) having suitable software and/or is connected to such a computing unit for this purpose.

The automated generation of first map contents is understood to mean that map contents are calculated using the data values of the surroundings and are inserted into the digital map.

A check of map contents is understood to mean, for example, a manual check, in particular a visual check, of the map contents by trained personnel, wherein any necessary changes are accordingly implemented.

An adjustment of map contents refers, for example, to a change in the position of map contents. For example, a lane boundary that was incorrectly or inaccurately calculated is moved after manual checking so that the adjusted position corresponds to the actual position of the lane boundary.

Secured algorithms are understood to mean computer-implemented calculation processes that meet specified requirements on functional safety in such a way that map contents calculated using these processes may be used to provide safety-relevant driving functions.

Providing a digital map is understood to mean, for example, that the digital map is stored or transmitted in a retrievable and/or transferable manner. In one embodiment, "providing" is understood to mean, for example, transferring the digital map to at least one (automated) vehicle and/or to another server and/or to a cloud.

In addition to special mapping vehicles, ordinary motor vehicles can contribute data values of the surroundings to the calculation of map contents using built-in sensor systems. However, map contents generated in this way are generally not secured and therefore are not available for use in safety-relevant driving functions. Manually checking a large number of such map contents is costly. One advantage of the presented method is that in particular hierarchical relationships between map contents can be used in such a way that part of the map contents is calculated automatically and is still secured. For this purpose, first map contents such as lane boundaries are calculated from data values of the surroundings. The first map contents are then manually checked and confirmed or adjusted, after which they are secured and are usable for safety-relevant driving functions. The secured first contents can then be used for the automated calculation of the second map contents. For example, road center lines or lane center lines can be calculated more easily starting from a checked and secured road boundary.

The combination of manual checking and automated calculation ensures the security of the map contents while simultaneously increasing the efficiency of the calculation. The presented method of the present invention thus enables, in particular, the coverage of lower road classes and the use of secured maps in urban driving functions.

The measures disclosed herein and explained in more detail below represent advantageous further developments and improvements of the method according to the present invention.

In a preferred design of the present invention, the digital map is converted into a standardized map format before checking the first map contents.

A standardized map format refers, for example, to the navigation data standard format (NDS).

One advantage of this design is that, with this sequence of method steps, the securing of the map contents is no longer affected by a subsequent conversion of the digital map or needs to be repeated.

In another preferred design of the present invention, on the basis of predefined safety requirements for the digital map, a decision is made as to which first map contents are automatically generated, checked, confirmed or adjusted, and which second map contents are automatically calculated and inserted using the secured algorithms.

Specified safety requirements include, for example, requirements for functional safety according to ISO 26262 or ISO 21448 (SOTIF).

The division into first and second map contents allows for a gradual increase in the level of automation of the method. If a higher level of security is required, more contents can be checked manually. If faster or more cost-effective map creation is required, more contents can be calculated automatically.

In another preferred design of the present invention, the checked and confirmed or adjusted first map contents, as well as the second, secured map contents, are inserted into another digital map which contains only secured map contents.

The term "another digital map" refers, for example, to a high-resolution HD map that is used to provide automated driving functions.

Since the additional digital map contains only secured map contents, it is advantageous to use the entire additional digital map to provide safety-relevant driving functions. Furthermore, the additional digital map can advantageously be offered at prices that economically reflect in particular the additional costs for securing the map contents.

In another preferred design of the present invention, the second map contents in particular are calculated using the secured algorithms in a cloud environment.

One advantage of this design is that computing resources can be used effectively, in particular for resource-intensive calculations using the secured algorithms. Furthermore, the checked first map contents can be used in this way to centrally calculate the second, secured map contents from a large number of data values of the surroundings of a large number of vehicles.

A device, in particular a computing unit, according to the present invention is configured to execute all steps of the method according to one of the example embodiments disclosed herein.

In one example embodiment of the present invention, the device in particular comprises a computing unit (processor, working memory, storage medium) and suitable software (computer program) in order to execute the method according to one of the method claims. In one embodiment, the device comprises a transmitting and/or receiving unit which is designed to exchange data values – in particular with an external server or a cloud. In another embodiment, the device is designed as a server or a cloud (i.e., a network of servers or computing units).

Furthermore, a computer program is provided according to the present invention, comprising commands that, when the computer program is executed by a computer, cause the computer to execute a method according to one of the disclosed embodiments of the present invention.

Furthermore, a machine-readable storage medium on which the computer program is stored is provided.

### BRIEF DESCRIPTION OF THE DRAWINGS

Exemplary embodiments of the present invention will be explained in detail below with reference to the figures.

FIG. 1 shows an exemplary embodiment of the method in the form of a flowchart, according to the present invention.

FIG. 2 shows an exemplary embodiment of the method for an exemplary road section of the map, according to the present invention.

### DETAILED DESCRIPTION OF EXAMPLE EMBODIMENTS

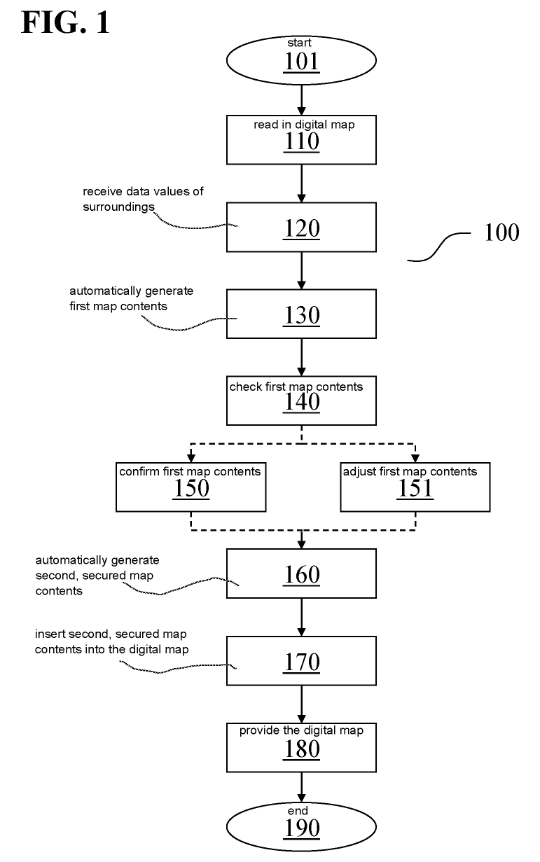

FIG. 1 shows an exemplary embodiment of a method 100 according to the invention in the form of a flow chart.

In step 101, the method 100 begins.

In step 110, the digital map is read in.

In step 120, data values of the surroundings are received, which represent the surroundings of at least one vehicle.

In step 130, first map contents are automatically generated from the received data values of the surroundings.

In step 140, the first map contents are checked.

The first map contents are then either confirmed in step 150 or adjusted in step 151.

In step 160, second, secured map contents are automatically calculated with the aid of the checked and confirmed or adjusted first map contents using secured algorithms.

In step 170, the second, secured map contents are inserted into the digital map.

In step 180, the digital map is provided.

In step 190, the method ends.

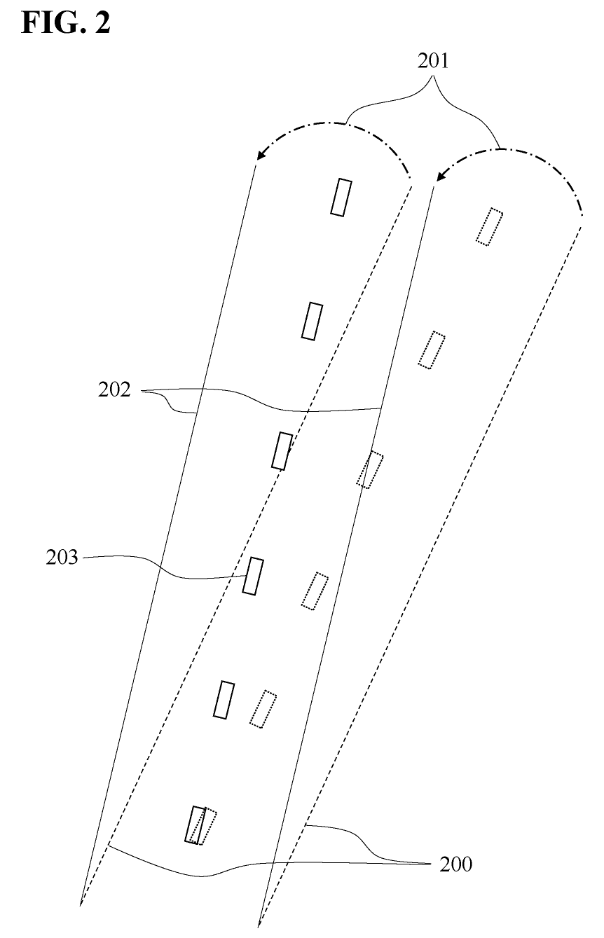

FIG. 2 shows an exemplary embodiment of the method for an exemplary road section of the map.

The lane boundaries 200 are automatically generated from received data values of the surroundings as an example of first map contents.

Subsequently, the lane boundaries 200 are checked and transferred to corrected positions 202 in step 201.

Using the corrected lane boundaries 202 as an example of checked and adjusted first map contents, the median strip 203 as an example of second, secured map contents is automatically calculated using secured algorithms.

What is claimed is:

1. A method for partially automated creation of contents for a digital map, comprising the following steps:
reading in the digital map;
receiving data values of surroundings which represent surroundings of at least one vehicle;
automatically generating first map contents from the received data values of the surroundings;
checking the first map contents;
confirming or adjusting the first map contents;
automatically calculating second, secured map contents using the checked, and the confirmed or adjusted first map contents, using secured algorithms;
inserting the second, secured map contents into the digital map; and
providing the digital map.

2. The method according to claim 1, wherein the digital map is converted into a standardized map format before he checking of the first map contents.

3. The method according to claim 1, wherein, based on predefined safety requirements for the digital map, a decision is made as to which of the first map contents are automatically generated, checked, and confirmed or adjusted, and which of the second map contents are automatically calculated and inserted using the secured algorithms.

4. The method according to claim 1, wherein the checked, and confirmed or adjusted first map contents, and the second, secured map contents, are inserted into another digital map which contains only secured map contents.

5. The method according to claim 1, wherein the second map contents are calculated using the secured algorithms in a cloud environment.

6. A device, comprising:
a computing unit configured to perform a method for partially automated creation of contents for a digital map, the method including the following steps:
reading in the digital map,
receiving data values of surroundings which represent surroundings of at least one vehicle,
automatically generating first map contents from the received data values of the surroundings,
checking the first map contents,
confirming or adjusting the first map contents,
automatically calculating second, secured map contents using the checked, and the confirmed or adjusted first map contents, using secured algorithms,
inserting the second, secured map contents into the digital map, and
providing the digital map.

7. A non-transitory machine-readable storage medium on which is stored a computer program for partially automated creation of contents for a digital map, the computer program, when executed by a computer, causing the computer to perform the following steps:
reading in the digital map;
receiving data values of surroundings which represent surroundings of at least one vehicle;
automatically generating first map contents from the received data values of the surroundings;
checking the first map contents;
confirming or adjusting the first map contents;
automatically calculating second, secured map contents using the checked, and the confirmed or adjusted first map contents, using secured algorithms;
inserting the second, secured map contents into the digital map; and
providing the digital map.
